(19) United States
(12) Patent Application Publication
(10) Pub. No.: US 2007/0174464 A1
(43) Pub. Date: Jul. 26, 2007

(54) Method of calling pc customer terminal transmitting its number in the media gateway control protocol

(76) Inventor: Quan Gan, Center Building (CN)

Correspondence Address: HARNESS, DICKEY & PIERCE, P.L.C., P.O. BOX 828, BLOOMFIELD HILLS, MI, 48303, US

(21) Appl. No.: 10/486,853

(22) PCT Filed: May 30, 2002
(86) PCT No.: PCT/CN02/00372

§ 371 Date: Feb. 16, 2004

(30) Foreign Application Priority Data
Aug. 15, 2001 (CN) 01124215.9

(51) Int. Cl. G06F 15/16

(52) U.S. Cl. 709/227; 709/217

(57) ABSTRACT

A method for a calling PCC transmitting its number includes the calling PCC issuing a RestartInProgress command to an One Name Link You (ONLY) server, and carrying in the EndPointId parameter of the RestartInProgress command a calling PCC number of the calling PCC for establishing a connection with the ONLY server. The ONLY server establishes the connection with the calling PCC through signaling interaction after the connection has been established. The ONLY server issues a CreateConnection command carrying the calling PCC number to a called PCC for establishing a connection with the called PCC; the called PCC obtaining the calling PCC number to establish a connection with the ONLY server through signaling interaction.

### FIELD OF THE TECHNOLOGY

The invention relates generally to an IP communication technology, especially to a method that makes a PC client call to carry the calling number in Media Gateway Control Protocol system.

### BACKGROUND OF THE INVENTION

At present, along with rapid development of telecommunication technology new services are continuously proposed and provided to users for the best and most convenient communication. One Number Link You (ONLY) is one of these new services. With the ONLY service, a unique private communication number (a virtual number) is assigned to a subscriber, and the ONLY service is implemented on a network combining the traditional PSTN network and the IP network. With this unique ONLY number, a subscriber at anywhere (such as at office, at home or on Internet) can be connected to make a real-time communication. The ONLY service deploys the media gateway, i.e. it is realized with separating media gateway controller and media gateway, wherein the PC client corresponds to the media gateway, and the ONLY server corresponds to the media gateway controller. The Media Gateway Control Protocol is deployed in communication between the PC client and the ONLY server. When the PC client is a calling, it must send its ONLY number to the called subscriber to display calling number.

In the MGCP, there is a specific event with calling identifier, i.e. calling identifier (CI) event that can take the calling number with three parameters: the time of the call (ti), the calling number (nu) and the calling name (na), and the CI event is transported as a requested event in the NotificationRequest command. This way of carrying a calling number is suitable for transmission of a calling number from the media gateway controller to the media gateway. When a PC client is a calling, the PC client cannot make transmission of a calling number using the CI event directly, since the PC client corresponds to a media gateway and the CI event can only be carried by a command from a media gateway controller to a media gateway. Therefore, this way of a calling number transmission cannot be used.

In the MGCP, there are all kinds of basic packages. Among them, there is a D package for transporting DTMF (double tone multiple frequency) code types. The transportation for DTMF code types is a DTMF code event in the MGCP. Table 1 shows transportation signals and their definition in the DTMF code events.

TABLE 1
Signals of DTMF code event

| Symbol | Definition | R | S | Duration |
|---|---|---|---|---|
| 0 | DTMF 0 | x | BR | |
| 1 | DTMF 1 | x | BR | |
| 2 | DTMF 2 | x | BR | |
| 3 | DTMF 3 | x | BR | |
| 4 | DTMF 4 | x | BR | |
| 5 | DTMF 5 | x | BR | |
| 6 | DTMF 6 | x | BR | |
| 7 | DTMF 7 | x | BR | |
| 8 | DTMF 8 | x | BR | |
| 9 | DTMF 9 | x | BR | |
| # | DTMF # | x | BR | |
| * | DTMF * | x | BR | |
| A | DTMF A | x | BR | |
| B | DTMF B | x | BR | |
| C | DTMF C | x | BR | |
| D | DTMF D | x | BR | |
| L | long duration indicator | x | | 2 seconds |
| X | Wildcard, match any digit 0-9 | x | | |
| T | Interdigit timer | x | | 4 seconds |
| of | report failure | x | | |

It seems that the PC client can send the calling number in the DTMF code event to the media gateway controller using the Notify command, but in real it is impossible, since the media gateway controller cannot require the media gateway (the PC client, in this invention) to detect the DTMF code event. More specifically, in the MGCP the notify command carry the events that are detected by media gateway according to event detection request in Notify Request command of the media gateway controller and occur at media gateway, but the DTMF code event cannot be detected by the media gateway except a subscriber types the keys actively (i.e. making the DTMF code event to occur).

### SUMMARY OF THE INVENTION

In accordance of the mention above, the objective of the invention is to provide a method in the MGCP: when the PC client makes a call, the calling number can be sent to the ONLY server (i.e. the media gateway controller) and then to the called subscriber.

For the above objective, the technical scheme of the invention is as follow.

A method for a PC client call carrying the calling number in the Media Gateway Control Protocol (MGCP) at least includes the following steps:

a. A calling PC client (PCC) issues a RestartInProgress command to an ONLY server to ask for establishing a connection with the ONLY server, the EndPointId in the RestartInProgess command is consisted by two parameters: calling number of the PCC and IP address of the PCC;

b. A connection between the ONLY server and the calling PCC is established through the signaling interaction between them;

c. After the connection between the ONLY server and the calling PCC has been established, the ONLY server issues a CreateConnection command to the called PCC to ask for establishing a connection and the CreateConnection command carrys the calling number;

d. A connection between the ONLY server and the called PCC is established through the signaling interaction between them.

Wherein said EndPointId parameter comprising the calling number of PCC, an endpoint sequence number and the IP address of calling PCC.

In step c, the CreateConnection command has an embedded NotificationRequest command that has a RequestedEvent parameter, and the calling number is put in the RequestedEvent parameter.

In the procedure above, the calling PCC or the called PCC communicates with the ONLY server using MGCP.

Since a PC client has its own unique ONLY number, i.e. calling number, and every PC client as a media gateway in the MGCP is identified by an endpoint, the key point of the invention is to combine a calling number with an endpoint identifier of the PCC in order to carry a calling number in an endpoint to a called PC client when the PC client initiates a call. It need not be expressed in special messages or parameters. In this invention, an endpoint identifier is expressed as:
EndPointId=<ONLY number>/1@<IP address>

Wherein the ONLY number is the ONLY number of the PC client, i.e. the calling number, “/1” is the sequence number of the endpoint, since every PC client has only one endpoint, the sequence number is “1” always in order to correspond to the MGCP.

It is obvious that the method of the invention solves the problem: when a PC client initiates a call, the calling number can be carried, i.e. the unique client identifier. The invention solves it without any special messages or parameters, but combining a calling number with an endpoint identifier of the PCC. Therefore, it is simple and convenient to implement.

### BRIEF DESCRIPTION OF THE DRAWINGS

FIG. 1 shows a diagram for a PC-to-PC call of the ONLY service.

### EMBODIMENTS OF THE INVENTION

The invention will be described in more detail with reference to the diagram.

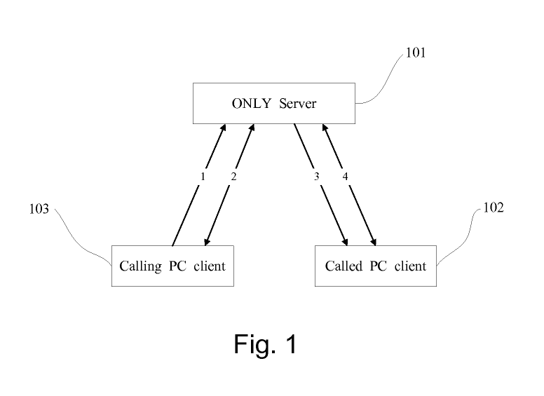

FIG. 1 shows a system for a call from one PC client to another PC client in the ONLY service and the procedure for establishing the call. When these two PCCs establish connection each other, they are through the ONLY server 101. Communication between a PCC and the ONLY server 101 uses the MGCP, wherein the ONLY server 101 corresponds to the media gateway controller (MGC) and a PCC corresponds to a media gateway (MG). The procedure at least includes the following steps.

(1) The calling PCC 103 initiates a call and issues a RestartInProgress command to the ONLY server. In MGCP, a media gateway (the calling PCC 103 in this case) can use the RestartInProcess command to notify the media gateway controller (the ONLY server in this case) that one or a group of endpoints managed by the gateway is taken in or out of service. The data structure of the RestartInProcess command is as following:

RestartInProgress (EndPointId,

RestartMethod,
[RestartDelay],
[Reason-code])

Wherein the endpoint identifier (EndPointId) is used to identify the endpoint of calling PCC 103, usually the EndPointId has two parameters: a Domain Name that the gateway belongs to, and a Local Name within the gateway. The invention uses the same format but changes the parameters as shown in the following:
<calling PCC number>/1@<calling PCC IP address>

In the format above, the calling number is put in the position of the LocalName of EndPointId. When the ONLY server has received the RestartInProgress command, it obtains the calling number. For example, suppose the calling number of the PC client is 16612345678 and the IP address of the PC client is 10.108.19.222, then the EndPointId is:
EndPointId=16612345678/1@10.108.19.222

(2) After the ONLY server receives the RestartInProcess command, the connection between the ONLY server 101 and the PCC 103 will be established through signaling interaction.

(3) After connection between the ONLY server 101 and the PCC 103 is established successfully, the ONLY server 101 will issue a CreateConnection command to the called PCC 102. CreateConnection command has an embededNotificationRequest command that has a RequestedEvents parameter that includes the CI event. Therefore, the ONLY server can transport the calling PCC 103 number through CI event, which has been taken from the EndPointId, to the called PCC 102, after that the called PCC 102 will obtain the calling PCC number from the CI event.

(4) After the PCC 102 receives the CreateConnection command, the connection between the ONLY server 101 and the PCC 102 will be established through signaling interaction.

It is clear from the procedure mentioned above, when a PC client is a calling, it can put the calling number as a parameter of a command and send the command to the ONLY server 101, and then the ONLY server 101 also can put the calling number as a parameter of another command and send it to the called PC client. In this way, the calling number is transported from the originating PC client to the receiving PC client of a call without changing commands structure or adding any new command, so it is simple, convenient and flexible.

1. A method for a calling PC client (PCC) transmitting its number in a Media Gateway Control Protocol (MGCP) system, comprising:
said calling PCC issuing a RestartInProgress command to an One Number Link You (ONLY) server for establishing a first connection with said ONLY server, an EndPointId parameter in said RestartInProgess command carrying a calling PCC number of said calling PCC, said calling PCC number being a logic identifier for identifying said calling PCC; said ONLY server establishing said first connection with said calling PCC by signaling interaction between said ONLY server and said calling PCC;
after said first connection having been established, said ONLY server issuing a CreateConnection command carrying said calling PCC number to a called PCC for establishing a second connection with said called PCC; said called PCC obtaining said calling PCC number for an ONLY service usage, establishing said second connection with said ONLY server by signaling interaction between said called PCC and said ONLY server.

2. The method according to claim 1 further comprising carrying an endpoint sequence number and an IP address of said calling PCC in said EndPointId parameter.

3. The method according to claim 1, further comprising putting said calling PCC number into a RequestedEvent parameter of a NotificationRequest command, and embedding said NotificationRequest command in said CreateConnection command before issuing said CreateConnection command.

4. The method according to claim 1, further comprising one of said calling PCC and said called PCC communicating with said ONLY server using Media Gateway Control Protocol.
